(19) United States
(12) Patent Application Publication
(10) Pub. No.: US 2026/0252819 A1
(43) Pub. Date: Aug. 27, 2026

(54) GUIDED SYNTHETIC DATA GENERATION FOR CONTEXTUAL REPRESENTATION

(71) Applicant: Microsoft Technology Licensing, LLC, Redmond, WA (US)

(72) Inventor: Jean-François LAVALLÉE, Trois-Rivières (CA)

(21) Appl. No.: 19/220,439

(22) Filed: May 28, 2025

Related U.S. Application Data
(60) Provisional application No. 63/764,339, filed on Feb. 27, 2025.

(51) Int. Cl. G06F 40/44; G06F 17/18

(52) U.S. Cl. CPC G06F 40/44; G06F 17/18

(57) ABSTRACT

A contextualized dataset generator selects one or more first deterministic annotations from a set of candidate deterministic annotations, wherein the set of candidate deterministic annotations correspond to a first data type identified in accordance with annotation selection rules. The contextualized dataset generator generates a first synthesizing instruction for input to a synthesizing language model based on the one or more first deterministic annotations, a synthesizing instruction template, and a scenario description specifying a task of a specified domain for which the machine learning model is to be trained or evaluated. The contextualized dataset generator synthesizes a first input prompt and one or more first probabilistic annotations by the synthesizing language model based on the first synthesizing instruction. The contextualized dataset generator adds a first datapoint to the annotated contextualized dataset, the first datapoint including the one or more first deterministic annotations, the first input prompt, and the first probabilistic annotations.

### CROSS-REFERENCE TO RELATED APPLICATION

This application claims priority to U.S. Provisional Application No. 63/764,339 filed on Feb. 27, 2025, and entitled “Guided Synthetic Data Generation for Contextual Representation.” The above-referenced priority application is specifically incorporated herein by reference for all that it discloses and teaches.

### BACKGROUND

Generating annotated data in natural language processing (NLP) applications has traditionally been challenging. For example, an annotation (e.g., a label) is knowledge associated with an input. Sets of inputs and training data may be used to train and/or evaluate a machine learning model. Some methodologies for generating annotated data involve manual annotation by domain experts, which takes significant time, consumes substantial monetary and expert resources, and risks introducing bias into the datasets, etc.

### SUMMARY

In some aspects, the techniques described herein relate to a computerized method of synthesizing an annotated contextualized dataset for a machine learning model, the computerized method including: selecting one or more first deterministic annotations from a set of candidate deterministic annotations, wherein the set of candidate deterministic annotations correspond to a first data type identified in accordance with annotation selection rules; generating a first synthesizing instruction for input to a synthesizing language model based on the one or more first deterministic annotations, a synthesizing instruction template, and a scenario description specifying a task of a specified domain for which the machine learning model is to be trained or evaluated; synthesizing a first input prompt and one or more first probabilistic annotations by the synthesizing language model based on the first synthesizing instruction; and adding a first datapoint to the annotated contextualized dataset, the first datapoint including the one or more first deterministic annotations, the first input prompt, and the one or more first probabilistic annotations.

In some aspects, the techniques described herein relate to a system for synthesizing an annotated contextualized dataset for a machine learning model, including: one or more hardware processors; an annotation identifier stored in memory and executable by the one or more hardware processors and configured to perform operations including selecting one or more first deterministic annotations from a set of candidate deterministic annotations, wherein the set of candidate deterministic annotations correspond to a first data type identified in accordance with annotation selection rules; a datapoints generator stored in memory and executable by the one or more hardware processors and configured to perform operations including: generating a first synthesizing instruction for input to a synthesizing language model based on the one or more first deterministic annotations, a synthesizing instruction template, and a scenario description specifying a task of a specified domain for which the machine learning model is to be trained or evaluated; and synthesizing a first input prompt and one or more first probabilistic annotations by the synthesizing language model based on the first synthesizing instruction; and a datapoints validator stored in memory and executable by the one or more hardware processors and configured to perform operations including adding a first datapoint to the annotated contextualized dataset, the first datapoint including the one or more first deterministic annotations, the first input prompt, and the one or more first probabilistic annotations.

In some aspects, the techniques described herein relate to one or more tangible processor-readable storage media embodied with instructions for executing on one or more processors and circuits of a computing device a process for synthesizing an annotated contextualized dataset for a machine learning model, the process including: selecting one or more first deterministic annotations from a set of candidate deterministic annotations, wherein the set of candidate deterministic annotations correspond to a first data type identified in accordance with annotation selection rules; generating a first synthesizing instruction for input to a synthesizing language model based on the one or more first deterministic annotations, a synthesizing instruction template, and a scenario description specifying a task of a specified domain for which the machine learning model is to be trained or evaluated; synthesizing a first input prompt and one or more first probabilistic annotations by the synthesizing language model based on the first synthesizing instruction; and adding a first datapoint to the annotated contextualized dataset, the first datapoint including the one or more first deterministic annotations, the first input prompt, and the one or more first probabilistic annotations.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment for generating an annotated contextualized dataset based on input data that may be used for training or evaluation of an artificial intelligence model.

FIG. 2 illustrates an example computing environment for generating an annotated contextualized dataset based on input data.

FIG. 3 illustrates an example process for generating an annotated contextualized dataset using a contextualized dataset generator.

FIG. 4 illustrates an example computing environment for performing a task-alignment post-processing operation on a datapoint to yield a task-aligned datapoint.

FIG. 5 depicts examples of operations for synthesizing an annotated contextualized dataset.

FIG. 6 illustrates an example computing device for use in implementing the described technology.

### DETAILED DESCRIPTIONS

Data annotation is often conducted manually, which can lead to excessive costs and introduce bias in the annotator. Annotated datasets generated through an exclusive manual process may maximize the dataset's quality, but the datasets may suffer from bias introduced by the annotator. Further, manually generating datasets is expensive, and because manual data generation is time-consuming, generating a dataset that is large enough to ensure adequate depth of representation of the user interaction is impractical using a manual annotation process.

The technology disclosed herein addresses these inadequacies of manual generation of annotated datasets by providing a contextualized dataset generator that uses a rules-guided selection of deterministic annotations (e.g., strong annotations), language-model-generated probabilistic annotations (e.g., weak annotations), synthesized input prompts (e.g., natural language inputs) corresponding to the deterministic annotations and the probabilistic annotations, and validation information to generate an annotated dataset that satisfies a predefined condition (e.g., a target complexity of the dataset is reached). Accordingly, the dataset generator of the disclosed technology synthesizes an annotated dataset that is a more accurate, less biased representation of the variety of user interactions than existing approaches.

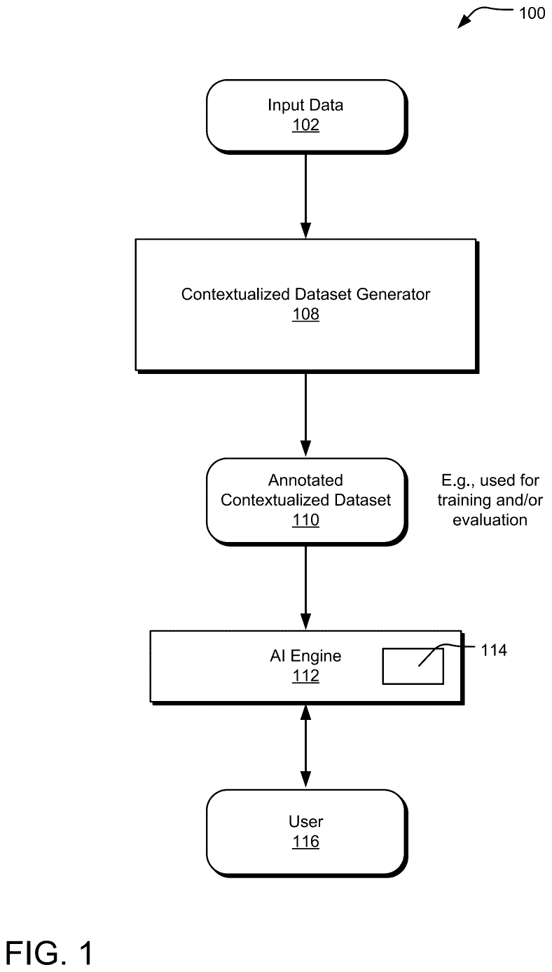

FIG. 1 illustrates an example computing environment for synthesizing an annotated contextualized dataset based on input data. The annotated contextualized dataset may be used for training or evaluating an artificial intelligence model. The example computing environment 100 includes a contextualized dataset generator 108 and an artificial intelligence (AI) engine 112. The contextualized dataset generator 108 accesses input data 102. In some implementations, the input data 102 is generated based on a hypothetical user interaction, for example, a customer conversation with an AI assistant (e.g., provided by the AI engine 112) involving a customer request for details about a luggage model.

The contextualized dataset generator 108 synthesizes an annotated contextualized dataset 110 using input data 102. The annotated contextualized dataset 110 includes a set of datapoints. Each datapoint includes an input prompt (e.g., a natural language input), one or more deterministic annotations corresponding to the input prompt, and one or more probabilistic annotations corresponding to the input prompt. In some implementations, one or more datapoints may not include any probabilistic annotations. The annotated contextualized dataset 110 may be used in one or more applications, for example, training a machine learning model and/or evaluating a machine learning model. For example, the annotated contextualized dataset 110 may be used to train and/or evaluate a machine learning model 114 utilized by an artificial intelligence (AI) engine 112. In such an example, the AI engine 112 may be an AI chatbot that conducts a user interaction (e.g., a series of questions/responses) with a user 116.

For example, the contextualized dataset generator 108 synthesizes an annotated contextualized dataset 110 to train a machine learning model of an AI assistant to book a flight for a user. The generated annotated contextualized dataset 110 may be used to train the AI assistant to learn the user's intent (e.g., desire to book a flight) at a current turn with a flight description collected through dialogue between the user and the AI assistant.

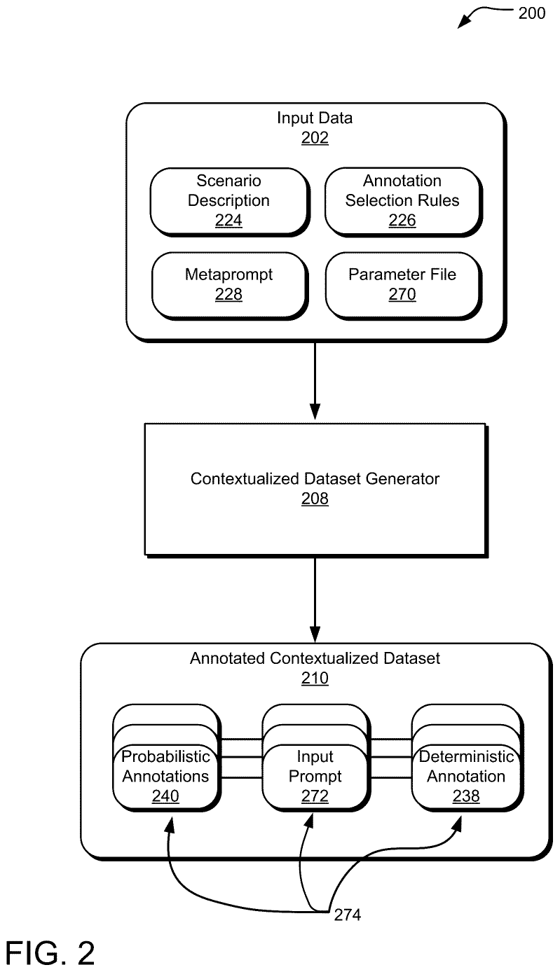

FIG. 2 illustrates an example computing environment 200 for synthesizing an annotated contextualized dataset 210 based on input data 202. The computing environment 200 is configured to generate the annotated contextualized dataset 210 based on the input data 202. The input data 202 includes, without limitation, annotation selection rules 226, a scenario description 224, a metaprompt 228, and a parameter file 270.

In some implementations, the annotation selection rules 226 define the type (e.g., a first data type(s)) of deterministic annotations that may be randomly selected from a set of candidate deterministic annotations.

A deterministic annotation is generated from deterministic means, such as a rules-based approach, and may be referred to as directed annotations or heuristic annotations. Data types that are selectable as deterministic annotations may differ according to the scenario description 224, which specifies a domain-specific context. In one example, the annotation selection rules 226, in the domain-specific context of a customer conversation with an AI assistant concerning purchasing and booking flights, defines an “actions” data type that includes deterministic annotations including “collect trip info,” “buying a ticket,” and “selecting a flight.” In another example, the annotation selection rules 226 in the domain-specific context of workplace process automation, define a “tools” data type that includes deterministic annotations including “send an email,” “web search,” “employee directory,” and “create workitem,” each of which is a tool that may be used in an automated process.

In contrast to a deterministic annotation, a probabilistic annotation is generated from probabilistic means, such as a generative artificial intelligence model, and may be referred to as generated annotations or model-generated annotations. Probabilistic annotations have data types different from the data types corresponding to strong annotations and may differ according to the scenario description 224, which specifies a domain-specific context. In some implementations, probabilistic annotations may include parameters that correspond to deterministic annotations. For example, in the domain-specific context of the customer conversation with the AI assistant concerning purchasing and booking flights, the probabilistic annotations may include “price,” (a parameter corresponding to the deterministic annotation of “select a flight”), “departure city,” “departure date,” “arrival city,” “arrival date,” (parameters corresponding to the deterministic annotation of “collect trip info”) and “flight company” and “class” (parameters corresponding to the deterministic annotation of “selecting a flight”). In another example, in the domain-specific context of workplace process automation, the probabilistic annotations may include “to,” “body,” “object” (parameters corresponding to the “send email” deterministic annotation), “user_ID” (parameter corresponding to “employee directory” deterministic annotation) “body,” and “title” (parameters corresponding to the “create work item” deterministic annotation).

For example, the contextualized dataset generator 208 generates an annotated contextualized dataset 210 to train an AI assistant to book a flight for a user. The generated annotated contextualized dataset 210 may be used to train the AI assistant to learn the user's intent (e.g., desire to book a flight) at a current turn with a flight description collected through dialogue between the user and the AI assistant. In this example, the annotation selection rules 226 may designate “actions” as deterministic annotations and other annotation types as probabilistic annotations. The deterministic annotations in this example may include [COLLECT_TRIP_INFO-Rules {Requirements: NOT SELECT_FLIGHT}, REJECT_FLIGHT-Rules {Requirements: COLLECT_TRIP_INFO AND NOT BUY_TICKET}, SELECT_FLIGHT-Rules {Requirements: COLLECT_TRIP_INFO AND NOT BUY_TICKET}, BUY_TICKET-Rules {Requirements: SELECT_FLIGHT.}] Potential probabilistic annotations may include PRICE, DEPARTURE_CITY, DEPARTURE_DATE, ARRIVAL_CITY, ARRIVAL_DATE, FLIGHT_COMPANY, and CLASS: [ECONOMY, BUSINESS, FIRST].

In some implementations, the scenario description 224 provides domain-specific context to the contextualized dataset generator 208 and can include static information and/or dynamic information. Static information includes information that is specific to the task and/or domain of the machine learning model for which the annotated contextualized dataset is generated. Examples of static information may include describing a task and/or domain of a machine learning model for which the annotated contextualized dataset is to be generated (e.g., an example task is “AI chatbot conversation about buying luggage” and an example domain is “luggage purchasing”). In contrast, dynamic information is information that introduces a variability in datapoint generation without impacting annotations. Dynamic information may include informing a tone, a style, a form, or content. For example, the dynamic information may indicate an angry mood of a customer during an interaction between the customer and an AI engine. As such, dynamic information can also guide the generation of the annotated contextualized dataset 210.

The metaprompt 228 includes a template used to create a synthesizing instruction to the contextualized dataset generator 208 to generate an input prompt (e.g., a natural language input, a machine language input, a vector communication input, an unstructured input, or other input for the annotated contextualized dataset 210) and corresponding probabilistic annotations by synthesizing a datapoint based on the deterministic annotations, the input prompt, probabilistic annotations. Each datapoint can be consumed by a machine learning model (e.g., for training and/or evaluation). The synthesizing instruction may be a synthesizing prompt that may be input to a language model to generate the input prompt and the probabilistic annotations to include in a datapoint, along with the deterministic annotation.

In some implementations, the parameter file 270 includes parameters that control the process for generating the annotated contextualized dataset 210. The parameters of the parameter file 270 may include, but are not limited to, a depth (e.g., a number of iterations), a minimum number and a maximum number of deterministic annotations to add at each iteration, a minimum number and a maximum number of knowledge sources to include in the annotated contextualized dataset 210. Example parameters can specify the complexity of the annotated contextualized dataset 210, the number of datapoints (e.g., input prompts with corresponding weak and deterministic annotations) generated, and how the datapoints are validated.

The annotated contextualized dataset 210 includes a set of datapoints, where each of the datapoints (e.g., the datapoint 274) includes an input prompt 272, one or more deterministic annotations (e.g., the deterministic annotation 238) corresponding to the input prompt 272, and one or more probabilistic annotations 240 corresponding to the input prompt 272. The correspondence is conceptually indicated in FIG. 2 using links that connect, for each datapoint (e.g., the datapoint 274), the probabilistic annotations (e.g., the probabilistic annotations 240) of the datapoint and the one or more deterministic annotations (e.g., the deterministic annotation 238) of the datapoint to the input prompt (e.g., the input prompt 272) of the datapoint. The input prompt 272 may include a natural language input (e.g., a text), a machine language input, or other input generated by a language model of the contextualized dataset generator 208. In some implementations, the contextualized dataset generator 208 generates the annotated contextualized dataset 210 in an iterative process that, at each iteration, selects one or more deterministic annotations (e.g., the deterministic annotation 238) and generates the corresponding input prompt 272 and corresponding one or more probabilistic annotations 240, and saves the datapoint in the annotated contextualized dataset 210. At each iteration, previously saved datapoints are used along with the input data 202 to inform the generation of the next datapoint, and so forth. The annotated contextualized dataset 210 illustrated in FIG. 2 shows three example datapoints; however, the contextualized dataset generator 208 may continue to add datapoints to the annotated contextualized dataset 210 until a depth condition is reached. The depth condition may be based on a number of iterations of the process for generating datapoints, a number of datapoints in the annotated contextualized dataset 210 (e.g., 10 datapoints, 15 datapoints, or another predefined threshold number of datapoints), a number of probabilistic annotations in the annotated contextualized dataset 210, or other criteria.

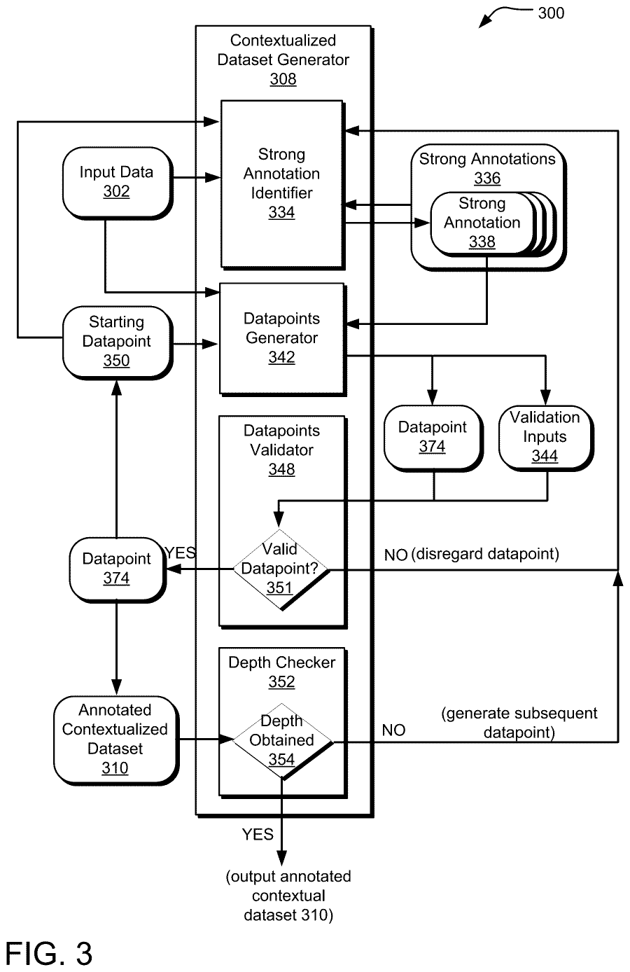

FIG. 3 illustrates an example process 300 for generating an annotated contextualized dataset 310 using a contextualized dataset generator 308. The contextualized dataset generator 308 includes a deterministic annotation identifier 334, a datapoints generator 342, a datapoints validator 348, and a depth checker 352.

The contextualized dataset generator 308 randomly selects one or more deterministic annotations (e.g., the deterministic annotation 338) from a set of deterministic annotations 336 based on annotation selection rules of the input data 302. For example, the input data 302 includes the annotation selection rules, a parameter file, a metaprompt, and a scenario description. The contextualized dataset generator 308 adds the selected one or more deterministic annotations (e.g., the deterministic annotation 338) to a starting point file. The process 300 depicted in FIG. 3 is an iterative process, and, in subsequent iterations, the annotation identifier 334 selects the one or more deterministic annotations based at least on a starting datapoint 350, which can include one or more previously generated datapoints.

The datapoints generator 342, guided by the metaprompt, populates generation values of a synthesizing prompt to be input to a language model (e.g., a large language model (LLM) or another language model) using the static information and dynamic information of the scenario description. The datapoints generator 342 generates an input prompt corresponding to the one or more deterministic annotations and generates probabilistic annotations to include in a datapoint with the selected one or more deterministic annotations (e.g., the deterministic annotation 338) by inputting the synthesizing prompt to the language model and obtaining the output of the language model that is generated based on the synthesizing prompt. In some implementations, the datapoints generator 342 includes the language model. The metaprompt includes a template that combines the dynamic/static information of the scenario description and selects one or more deterministic annotations in a way that can be used to generate the synthesizing prompt for obtaining data from the language model to include in the datapoint.

The datapoints validator 348 validates the input prompt and the probabilistic annotations. The metaprompt includes validation information to include within the synthesizing instruction, and validation of the input prompt and the probabilistic annotations may include comparing the deterministic annotations with the output data of the language model to identify whether the deterministic annotations were generated in the output data. Validation may also include verifying that the format of the generated probabilistic annotations corresponds to a predefined format. Validation may also include verifying that the language model followed the synthesizing instruction correctly by adding instructions in the synthesizing instruction that are not necessary to the datapoint generation itself but to which the language model's response can be verified. In some implementations, the language model outputs a keyword (e.g., a keyword reading “impossible”) when the one or more deterministic annotations cannot be used by the language model to generate a coherent input prompt, and the datapoints validator 348 accordingly determines that the generated probabilistic annotation(s) are not validated. At block 351, if the input prompt and probabilistic annotations are not valid, the datapoint (the deterministic annotation, input prompt, and probabilistic annotations) is disregarded, and the process 300 is repeated from the beginning. For example, the deterministic annotations identifier 334 randomly selects one or more subsequent deterministic annotations from the set of deterministic annotations 336 based on the starting datapoint 350 (if applicable) and the input data 302, the datapoints generator 342 generates a subsequent datapoint corresponding to the subsequent one or more deterministic annotations, and the datapoints validator 348 adds the subsequent datapoint to the annotated contextualized dataset 310 and to the starting datapoint 350, and so forth until process 300 is repeated enough times to satisfy the depth threshold. For example, the depth threshold may specify a number of iterations of the process 300.

At block 351, responsive to validating the input prompt and the probabilistic annotations generated by the datapoints generator 342, the datapoints validator 348 generates a datapoint 374 that includes the validated input prompt (e.g., natural language input, machine language input, etc.), the one or more deterministic annotations corresponding to the validated input prompt, and the validated probabilistic annotations. The datapoints validator 348 adds the datapoint 374 to the annotated contextualized dataset 310 and also adds the datapoint 374 to the starting datapoint 350. For example, the starting datapoint 350 is used as input to both the deterministic annotations identifier 334 and the datapoints generator 342 for generating subsequent datapoints. In some implementations, the annotation section rules specify how the starting datapoint 350 is used to select subsequent strong annotation(s) for the next iteration of the process 300, and are configurable by an operator of the contextualized dataset generator. For example, the annotation selection rules may specify that, for a set of candidate deterministic annotations (e.g., deterministic annotations A, B, C, D, E), a previously selected deterministic annotation cannot be repeated and that selection of deterministic annotation C requires the presence of deterministic annotation A in one or more datapoints of the starting datapoint 350, and that selection of deterministic annotation D requires the presence of deterministic annotation B in one or more datapoints of the starting datapoint 350. In this example, in a first iteration of process 300 with no datapoints in the starting datapoint 350, the deterministic annotation of the set [A, B, E] and the deterministic annotation B is selected. Continuing with this example, in the next iteration of process 300, the starting datapoint 350 includes a datapoint having the deterministic annotation [B] and, in accordance with the annotation selection rules, the candidate deterministic annotations can be selected to include deterministic annotations [A, D, E]. This example rule is one example of how annotation selection rules may constrain or otherwise guide the selection of deterministic annotations, and annotation selection rules may be customizable by the operator of the contextualized dataset generator.

The depth checker 352 determines whether a predefined threshold depth corresponding to the annotated contextualized dataset 310 has been satisfied. For example, the predefined threshold depth may be a predefined number of iterations of the process 300, or another complexity metric. For example, the greater the depth, the greater the number of validated datapoints that will be generated from the annotated contextualized dataset 310. At block 354, responsive to determining that the predefined threshold depth (or another predefined complexity metric) has not been reached, the deterministic annotations identifier 334 randomly selects one or more subsequent deterministic annotations from the set of deterministic annotations 336 based on the starting datapoint 350 and the input data 302, the datapoints generator 342 generates a subsequent datapoint corresponding to the subsequent one or more deterministic annotations, and the datapoints validator 348 adds the subsequent datapoint to the annotated contextualized dataset 310 and to the starting datapoint 350, and so forth until process 300 is repeated enough times to satisfy the depth threshold. At block 354, responsive to determining that the predefined depth threshold for the annotated contextualized dataset 310 has been satisfied, the depth checker 352 outputs the annotated contextualized dataset 310. In some implementations, the contextualized dataset generator 308 performs post-processing task-alignment operations on one or more datapoints of the annotated contextualized dataset 310. Post-processing task-alignment operations may include scrubbing of terms of the input prompts (e.g., natural language inputs) of the datapoints before outputting the annotated contextualized dataset 310.

Continuing with the above-described example concerning generating an annotated contextualized dataset 310 to train an AI assistant to book a flight for a user, the first iteration of the process 300 begins with a starting datapoint 350 that is empty. A deterministic annotation of “COLLECT_TRIP_INFO” is selected by the deterministic annotation identifier 334. For example, the deterministic annotations in this example that are selectable may include [COLLECT_TRIP_INFO-Rules {Requirements: NOT SELECT_FLIGHT}, REJECT_FLIGHT-Rules {Requirements: COLLECT_TRIP_INFO AND NOT BUY_TICKET}, SELECT_FLIGHT-Rules {Requirements: COLLECT_TRIP_INFO AND NOT BUY_TICKET}, BUY_TICKET-Rules {Requirements: SELECT_FLIGHT.}] Potential probabilistic annotations may include PRICE, DEPARTURE_CITY, DEPARTURE_DATE, ARRIVAL_CITY, ARRIVAL_DATE, FLIGHT_COMPANY, and CLASS: [ECONOMY, BUSINESS, FIRST].

The datapoints generator 342 generates an input prompt (e.g., natural language input) that reads “User: I want to book a ticket to Los Angeles,” along with a probabilistic annotation of “[ARRIVAL_CITY: Los Angeles]” and validation inputs 344 of “INTENT: COLLECT_TRIP_INFO.” In this example, the datapoints validator 348 determines that the first datapoint is valid because the intent returned by the datapoints generator 342 corresponds to the deterministic annotation. The datapoints validator 348 adds the first datapoint (e.g., the deterministic annotation, the probabilistic annotation, and the input) to the annotated contextualized dataset 310 and to the starting datapoint 350. For example, the annotations of the first datapoint are “INTENT: COLLECT_TRIP_INFO, ENTITIES: [ARRIVAL_CITY: Los Angeles], and the input of the first datapoint is “User: I want to book a ticket to Los Angeles.”

Continuing with this example, in a second iteration of the process 300, the starting datapoint 350 reads “Context: [ ], Input: I want to book a ticket to Los Angeles, Annotation INTENT: COLLECT_TRIP_INFO, ENTITIES: [ARRIVAL_CITY: Los Angeles]” A subsequent deterministic annotation of COLLECT_TRIP_INFO, which corresponds to the first selected deterministic annotation, is chosen by the deterministic annotation identifier 334. The datapoints generator 342 generates an input prompt that reads “System: Sure, where and when are you leaving User: Next Monday from Paris. I prefer European airlines,” along with a probabilistic annotation of [DEPARTURE_CITY: Paris, DEPARTURE_DATE: May 2, 2025, FLIGHT_COMPANY: European airlines]” and validation information of “INTENT: COLLECT_TRIP_INFO.” In this example, the datapoints validator 348 determines that the probabilistic annotation is valid because the intent returned by the datapoints generator 342 corresponds to the deterministic annotation. The datapoints validator 348 adds the second datapoint (e.g., the deterministic annotation, the probabilistic annotation, and the input) to the annotated contextualized dataset 310 and to the starting datapoint 350. For example, the annotations of the second datapoint are “INTENT: COLLECT_TRIP_INFO, ENTITIES: [ARRIVAL_CITY: Los Angeles, DEPARTURE_CITY: Paris, DEPARTURE_DATE: May 2, 2025, FLIGHT_COMPANY: European airlines]” and the input of the second datapoint is “System: Sure, where and when are you leaving User: Next Monday from Paris. I prefer European airlines.”

Continuing with this example, in a third iteration of the process 300, the starting datapoint 350, which includes the first datapoint and the second datapoint, reads “Context:[ ], Input: I want to book a ticket to Los Angeles, Annotation INTENT: COLLECT_TRIP_INFO, ENTITIES: [ARRIVAL_CITY: Los Angeles], Input: System: Sure, where and when are you leaving User: Next Monday from Paris. I prefer European airlines] INTENT: COLLECT_TRIP_INFO, ENTITIES: [ARRIVAL_CITY: Los Angeles, DEPARTURE_CITY: Paris, DEPARTURE_DATE: May 2, 2025, FLIGHT_COMPANY: European airlines]” A subsequent deterministic annotation of SELECT_FLIGHT is selected by the deterministic annotation identifier 334. The datapoints generator 342 generates an input prompt that reads “System: I have an Air France flight leaving at Noon and a KLM flight leaving at 10 μm User: I'll take the second one,” along with a probabilistic annotation of “[DEPARTURE_DATE: 22h00m, FLIGHT_COMPANY: KLM]” and validation information of “INTENT: SELECT_FLIGHT.” In this example, the datapoints validator 348 validates the probabilistic annotation because the intent returned by the datapoints generator 342 corresponds to the deterministic annotation. The datapoints validator 348 saves the third datapoint (e.g., the deterministic annotation, the probabilistic annotation, and the input) to the annotated contextualized dataset 310 and to the starting datapoint 350. For example, the annotations of the third datapoint are “INTENT: SELECT_FLIGHT, ENTITIES: [ARRIVAL_CITY: Los Angeles, DEPARTURE_CITY: Paris, DEPARTURE_DATE: May 2, 2025 22h00m, FLIGHT_COMPANY: KLM]” and the input of the third datapoint is “System: Sure, where and when are you leaving User: Next Monday from Paris. I prefer European airlines.”

Continuing with this example, the first, second, and third datapoints of the generated annotated contextualized dataset are represented in the following table:

| | Intent Annotation | Entities Annotation (Probabilistic |
|---|---|---|
| Input | (Deterministic annotation) | annotation |
| User: I want to book a | COLLECT_TRIP_INFO | [ARRIVAL_CITY: Los Angeles] |
| ticket to Los Angeles | | |
| System: Sure, where | COLLECT_TRIP_INFO | [DEPARTURE_CITY:Paris, |
| and when are you | | DEPARTURE_DATE: 05/02/2025, |
| leaving? User: Next | | FLIGHT_COMPANY: European |
| Monday from Paris. I | | airlines] |
| prefer European | | |
| airlines. | | |
| System: I have an Air | SELECT_FLIGHT | [ARRIVAL_CITY:Los Angeles, |
| France flight leaving | | DEPARTURE_CITY:Paris, |
| at Noon and a KLM | | DEPARTURE_DATE: 05/02/2025 |
| flight departing at 10 | | 22h00m, |
| pm. User: I'll take the | | FLIGHT_COMPANY:KLM] |
| second one | | |

In some implementations, the first datapoint may not be used when the annotated contextualized dataset represents a multi-turn conversation, as in this example.

In another example, an annotated contextualized dataset 310 is generated for training an AI agent to automate a common workflow for office work. In this example, the annotation selection rules may designate “tools” as a deterministic annotation and other types of annotations (e.g., parameters associated with tools) as probabilistic annotations. The deterministic annotations in this example may include “Send_email; Receive_email; LLM_RESUME; WEB_SEARCH, INTERNAL_SEARCH, EMPLOYEE_DIRECTORY, and CREATE_WORKITEM. The probabilistic annotations (parameters) in this example corresponding to the deterministic annotations may include “Send_email, parameters: TO, BODY, OBJECT; Receive_email, parameters: FROM, BODY, OBJECT; LLM_RESUME, parameters: ORIGINAL, TARGET_SIZE; WEB_SEARCH, parameters: QUERY; INTERNAL_SEARCH, parameters: QUERY; EMPLOYEE_DIRECTORY, parameters: USER_ID; CREATE_WORKITEM, parameters: BODY, TITLE.”

Continuing with this example, the first iteration of process 300 begins with a starting datapoint of 350 that is empty. Deterministic annotations of “Receive_email, LLM_RESUME, CREATE_WORKITEM” are selected by the deterministic annotation identifier 334. The datapoints generator 342 generates an input prompt that reads “When I receive an email from the PM with the object containing bug or issue, create a new workitem with the resume of the email,” along with a probabilistic annotations parameters of “[Receive_email.FROM=PM, Receive_email.OBJECT=bug or issue, CREATE_WORKITEM.Body=LLM_RESUME (ORIGINAL=Receive_email.BODY)]” and validation information of “TOOLS: RECEIVE-EMAIL, LLM_RESUME, CREATE_WORKITEM.” In this example, the datapoints validator 348 determines that the first datapoint is valid because the tools returned by the datapoints generator 342 correspond to the selected deterministic annotations. The datapoints validator 348 adds the first datapoint (e.g., the deterministic annotations, the probabilistic annotations parameters, and the input) to the annotated contextualized dataset 310 and to the starting datapoint 350. For example, the annotations of the first datapoint are “TOOLS: RECEIVE-EMAIL, LLM_RESUME, CREATE_WORKITEM, PARAMETERS: [Receive_email.FROM=PM, Receive_email.OBJECT=bug or issue, CREATE_WORKITEM.Body=LLM_RESUME (ORIGINAL=Receive_email.BODY)]” and the input of the first datapoint is “When I receive a email from the PM with the object containing bug or issue, create a new workitem with the resume of the email.”

Continuing with this example, in a second iteration of the process 300, the starting datapoint 350 reads “{Input: When I receive an email from the PM with the object containing bug or issue, create a new workitem with the resume of the email Annotation TOOLS_SEQUENCE: [Receive_email, LLM_RESUME, CREATE_WORKITEM] Annotation PARAMETERS: [Receive_email.FROM=PM, Receive_email.OBJECT=bug or issue, CREATE_WORKITEM.Body=LLM_RESUME (ORIGINAL-Receive_email.BODY)]}” A subsequent deterministic annotation of “send_email,” is selected by the deterministic annotation identifier 334 and added to the previous deterministic annotation to yield “RECEIVE_EMAIL, LLM_RESUME, CREATE_WORKITEM, SEND_EMAIL.” The datapoints generator 342 generates an input prompt that reads, “When I receive an email from the PM with the object containing a bug or issue, create a new workitem with the resume of the email and send the link to the items to my manager,” probabilistic annotations parameters of “[Receive_email.FROM=PM, Receive_email.OBJECT=bug or issue, CREATE_WORKITEM.Body=LLM_RESUME (ORIGINAL=Receive_email.BODY), Send_email.TO=my manager, Send_email.BODY=CREATE_WORKITEM.link],” and validation information of “TOOLS: Receive_email, LLM_RESUME, CREATE_WORKITEM, Send_email.” In this example, the datapoints validator 348 determines that the probabilistic annotation is valid because the tools sequence returned by the datapoints generator 342 corresponds to the cumulative tools identified in the selected deterministic annotation and the previous deterministic annotation of the previous iteration. The datapoints validator 348 adds the second datapoint (e.g., the deterministic annotation plus previous deterministic annotation, the probabilistic annotation, and the input) to the annotated contextualized dataset 310 and to the starting datapoint 350. For example, the annotations of the second datapoint are “TOOLS_SEQUENCE: [Receive_email, LLM_RESUME, CREATE_WORKITEM, Send_email] PARAMETERS: [Receive_email.FROM=PM, Receive_email.OBJECT=bug or issue, CREATE_WORKITEM.Body=LLM_RESUME (ORIGINAL=Receive_email.BODY), Send_email.TO=my manager, Send_email.BODY=CREATE_WORKITEM.link]” and the input of the second datapoint is “When I receive an email from the PM with the object containing a bug or issue, create a new workitem with the resume of the email and send the link to the items to my manager.”

Continuing with this example, the first and second datapoints of the generated annotated contextualized dataset are represented in the following table:

| | Tools Annotations | Parameters Annotation (Probabilistic |
|---|---|---|
| Input | (Deterministic annotations) | annotations |
| When I receive an | TOOLS_SEQUENCE: | PARAMETERS: |
| email from the PM | [Receive_email, | [Receive_email.FROM = PM, |
| with the object | LLM_RESUME, | Receive_email.OBJECT = bug or issue, |
| containing a bug or | CREATE_WORKITEM] | CREATE_WORKITEM.Body= |
| issue, create a new | | LLM_RESUME(ORIGINAL= |
| workitem with the | | Receive_email.BODY)] |
| resume of the email. | | |
| When I receive an | TOOLS_SEQUENCE: | PARAMETERS: |
| email from the PM | [Receive_email, | [Receive_email.FROM = PM, |
| with the object | LLM_RESUME, | Receive_email.OBJECT = bug or issue, |
| containing a bug or | CREATE_WORKITEM, | CREATE_WORKITEM.Body= |
| issue, create a new | Send_email] | LLM_RESUME(ORIGINAL= |
| workitem with the | | Receive_email.BODY), |
| resume of the email | | Send_email.TO=my manager, |
| and send the link to | | Send_email.BODY=CREATE_WO |
| the items to my | | RKITEM.link] |
| manager. | | |

The annotated contextualized dataset 310 may be used for various purposes; for example, the annotated contextualized dataset 310 may represent a conversation with an AI assistant and provide context for a subsequent conversation with the AI assistant. The annotated contextualized dataset 310 may be used to train a language model (e.g., the language model) or other machine learning models, for example, to enable the model to learn patterns and make predictions. The annotated contextualized dataset 310 may be used for evaluating a machine learning model. For example, the annotations of the annotated contextualized dataset 310 may be compared against predictions of the machine learning model to measure accuracy or other performance metrics for the machine learning model.

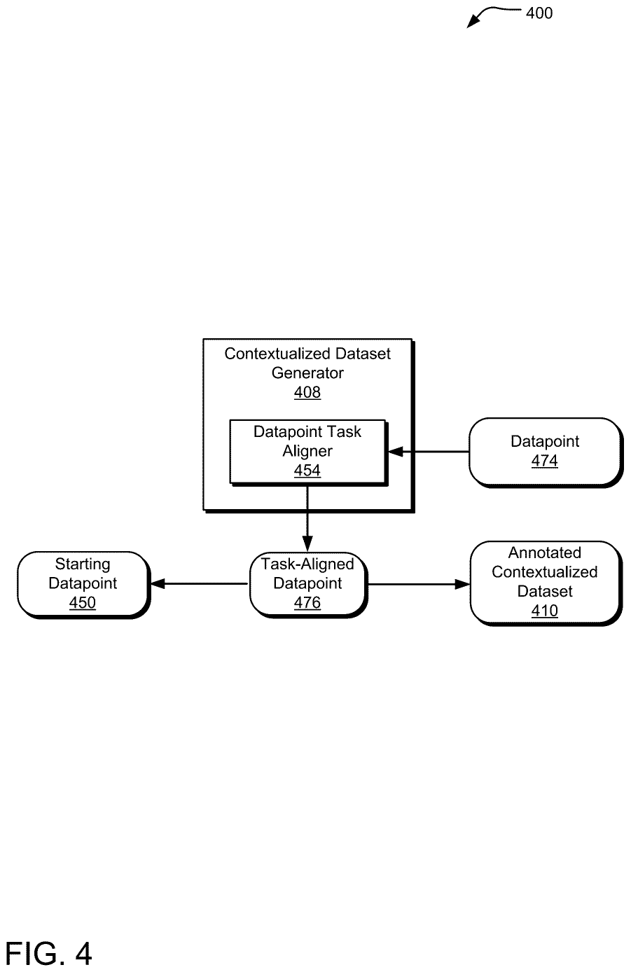

FIG. 4 illustrates an example computing environment 400 for performing a task-alignment post-processing operation on a datapoint 474 to yield a task-aligned datapoint 476. The example computing environment 400 includes a contextualized dataset generator 408, which includes a datapoint task aligner 454. The datapoint task aligner 454 scrubs or performs other post-processing task-alignment operations on each validated datapoint (e.g., the datapoint 474) to yield a corresponding task-aligned datapoint (e.g., the task-aligned datapoint 476) and adds the corresponding task-aligned datapoint to the annotated contextualized dataset 410 and to the starting datapoint 450 (e.g., for use in selecting a subsequent deterministic annotation and generating a subsequent datapoint). The post-processing task-alignment operations may vary according to the scenario description. For example, different types of task-alignment operations may be performed for the scenario of generating an annotated contextualized dataset for training an AI chatbot to interact with a user to purchase tickets than for the scenario of training an AI agent to generate automated workflows. Scrubbing is one example of a post-processing task-alignment operation and may include removing specific details from a datapoint 474, for example, changing “I'm calling about the red Mustang we discussed last week” in the input prompt of the datapoint 474 to “I'm calling about the car we discussed previously.” In this example, the datapoint task aligner 454 detects specific terms and then removes one or more specific terms and/or replaces one or more specific terms with more generic terms. For example, the datapoint task aligner 454 may replace proper nouns (e.g., mustang) with generic nouns (e.g., car), replace specific nouns (e.g., last week) with more generic nouns (e.g., previously), remove adjectives (e.g., red), or perform other replacements of words to make the task-aligned datapoint 476 more generic than the original datapoint 474. In some implementations, the contextualized dataset generator 408 performs other task alignment post-processing on the datapoint 474 other than or in addition to scrubbing the datapoint 474. For example, the contextualized dataset generator 408 may request a language model (e.g., an LLM) to rewrite the text of the input prompt of the datapoint 474 to remove all information that can be inferred from the context and to use anaphora instead whenever possible.

In another example, post-processing task alignment may include converting parameter values associated with tools (e.g., see the example from FIG. 3 concerning training a model to automate a common workflow for office work). In this example, the task alignment includes converting the parameter value into values that can be used by the tools and generation of code. For example, “Receive_email.FROM=PM [project manager]” may be converted to “Receive_email.FROM=mjackson@companyname.com,” “Receive_email. OBJECT=bug or issue,” may be converted to “Receive_email. OBJECT=.*(bug|issue).*,” and “Send_email. TO-my manager,” may be converted to Send_email.TO=fbelanger@companyname.com. Post-processing task alignment may also include generating code from the tools sequence and parameters. For example, in a first iteration of code generation, the following code may be generated:
Email=Receive_email
If Email.OBJECT.match (.*(bug|issue).*) and
Email.FROM==mjackson@companyname.com
Resume=LLM_RESUME (ORIGINAL: Email.BODY)
CREATE_WORKITEM (Body: Resume),
and a second iteration of code generation may generate:
   Email=Receive_email
   If Email.OBJECT.match (.*(bug|issue).*) and
   Email.FROM==mjackson@companyname.com
   Resume=LLM_RESUME (ORIGINAL: Email.BODY)
   Link=CREATE_WORKITEM (Body: Resume)
   Send_email (TO: fbelanger@companyname.com, BODY: Link)

Continuing with this example, the post-processed task-aligned contextualized dataset 410 is represented in the following table:

| Input | Code |
|---|---|
| When I receive | Email = Receive_email |
| an email from | If Email.OBJECT.match(.*(bug\|issue).*) and |
| the PM with | Email.FROM==mjackson@companyname.com |
| the object | Resume = LLM_RESUME(ORIGINAL: |
| containing a | Email.BODY) |
| bug or issue, | CREATE_WORKITEM(Body: Resume) |
| create a new | |
| workitem with | |
| the resume of | |
| the email. | |
| When I receive | Email = Receive_email |
| an email from | If Email.OBJECT.match(.*(bug\|issue).*) and |
| the PM with | Email.FROM==mjackson@companyname.com |
| the object | Resume = LLM_RESUME(ORIGINAL: |
| containing a | Email.BODY) |
| bug or issue, | Link = CREATE_WORKITEM(Body: |
| create a new | Resume) |
| workitem with | Send_email(TO: fbelanger@companyname.com, |
| the resume of | BODY:Link) |
| the email and | |
| send the link | |
| to the items to | |
| my manager. | |

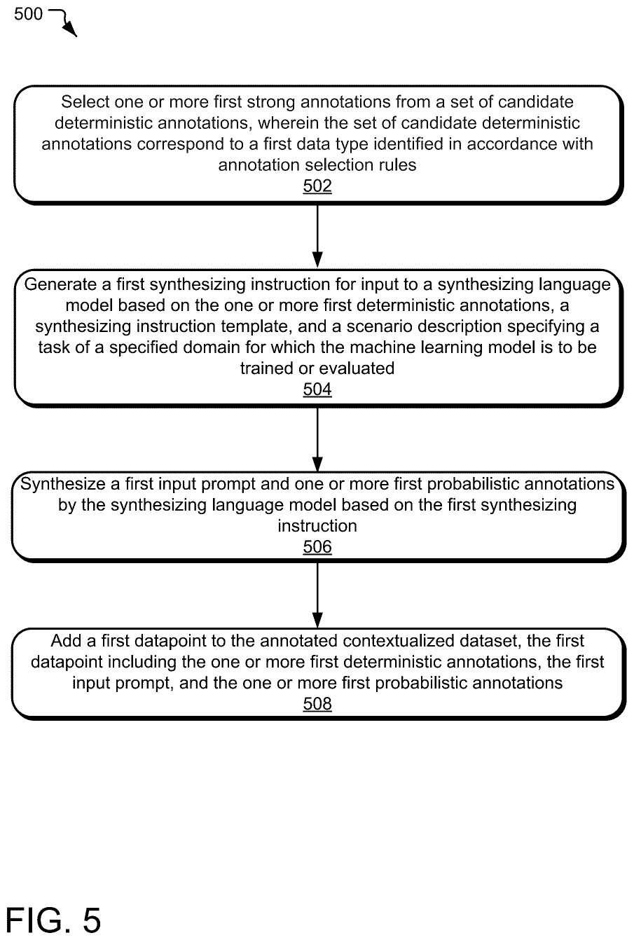

FIG. 5 depicts example operations 500 for synthesizing an annotated contextualized dataset. In some implementations, the example operations 500 are performed by one or more of a contextualized dataset generator and a synthetic input generator.

An example selecting operation 502 selects one or more first deterministic annotations from a set of candidate deterministic annotations, wherein the candidate deterministic annotations correspond to a first data type identified in accordance with annotation selection rules.

An example generating operation 504 generates a first synthesizing prompt for input to a synthesizing language model based on the one or more first deterministic annotations, a prompt template, and a scenario description specifying a task of a specified domain for which the machine learning model is to be trained or evaluated. In some implementations, the scenario description further specifies a tone.

An example synthesizing operation 506 synthesizes a first input prompt and one or more first probabilistic annotations by the synthesizing language model based on the first synthesizing prompt. In some implementations, the first data type includes intents, and the one or more first probabilistic annotations correspond to second data types including one or more of files, inputs, outputs, actions, entities, or sentiments. In some implementations, a task-alignment post-processing task is performed on the one or more first probabilistic annotations of the annotated contextualized dataset to replace one or more portions of the one or more first probabilistic annotations with replacement portions.

An example adding operation 508 adds a first datapoint to the annotated contextualized dataset, the first datapoint including the one or more first deterministic annotations, the first input prompt, and the one or more first probabilistic annotations. In some implementations, the one or more first deterministic annotations and the one or more first probabilistic annotations are associated with the first input prompt in the first datapoint. In some implementations, additional datapoints are generated for inclusion in the annotated contextualized dataset with the first datapoint until a predefined depth threshold is met. In some implementations, (1) one or more second deterministic annotations are selected from the candidate deterministic annotations in accordance with the annotation selection rules, (2) a second synthesizing prompt is generated for input to the synthesizing language model based on the first datapoint, the prompt template, and the scenario description, (3) a second input prompt and one or more second probabilistic annotations are synthesized by the synthesizing language model based on the second synthesizing prompt, and (4) a second datapoint is added to the annotated contextualized dataset, the second datapoint including the one or more second deterministic annotations, the second input prompt, and the one or more second probabilistic annotations.

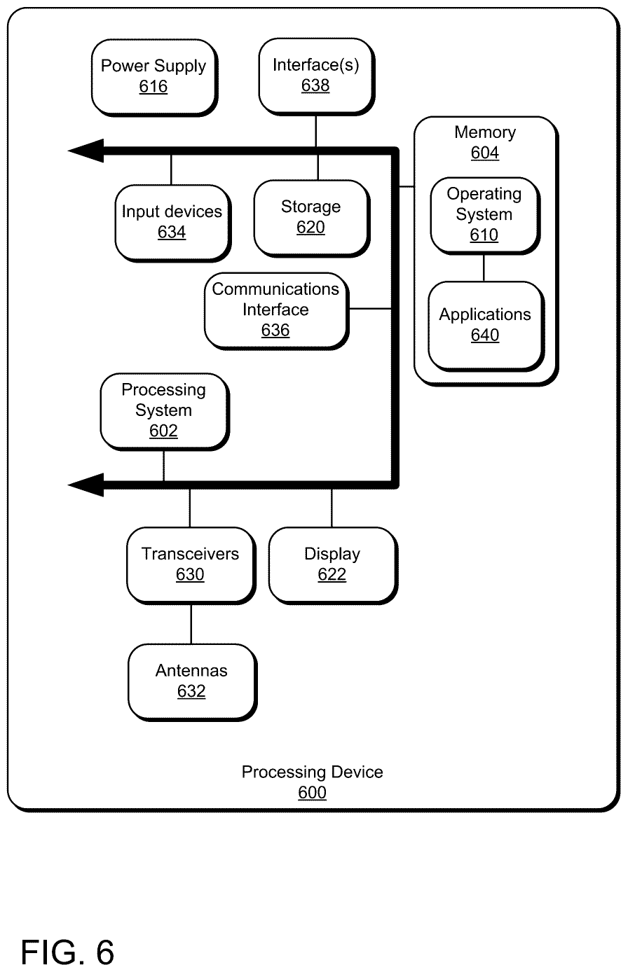

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the one or more hardware processors 602. In some implementations, the computing device 600 includes and/or is communicatively coupled to storage 620.

In the example computing device 600, as shown in FIG. 6, one or more software processing engines, segments, and/or processors, such as applications 640, a contextualized dataset generator, an AI engine, a deterministic annotation identifier, a datapoints generator, a datapoints validator, a depth checker, an annotation task aligner, a language model, and other program code and modules are loaded into the operating system 610 on the memory 604 and/or the storage 620 and executed by the one or more hardware processors 602. The storage 620 may store input prompts, an annotated contextualized dataset, input data, a scenario description, a parameter file, annotation selection rules, a metaprompt, annotations, deterministic annotations, probabilistic annotations, starting datapoint(s), input prompts, validated probabilistic annotations, validated input prompt, scrubbed annotations, and other data and be local to the computing device 600 or may be remote and communicatively connected to the computing device 600. In particular, in one implementation, components of a system for generating an annotated contextualized dataset may be implemented entirely in hardware or in a combination of hardware circuitry and software.

The computing device 600 includes a power supply 616, which may include or be connected to one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computerized method of synthesizing an annotated contextualized dataset for a machine learning model, the computerized method comprising: selecting one or more first deterministic annotations from a set of candidate deterministic annotations, wherein the set of candidate deterministic annotations correspond to a first data type identified in accordance with annotation selection rules; generating a first synthesizing instruction for input to a synthesizing language model based on the one or more first deterministic annotations, a synthesizing instruction template, and a scenario description specifying a task of a specified domain for which the machine learning model is to be trained or evaluated; synthesizing a first input prompt and one or more first probabilistic annotations by the synthesizing language model based on the first synthesizing instruction; and adding a first datapoint to the annotated contextualized dataset, the first datapoint including the one or more first deterministic annotations, the first input prompt, and the one or more first probabilistic annotations.

Clause 2. The computerized method of clause 1, wherein the one or more first deterministic annotations and the one or more first probabilistic annotations are associated with the first input prompt in the first datapoint.

Clause 3. The computerized method of clause 1, further comprising: generating additional datapoints for inclusion in the annotated contextualized dataset with the first datapoint until a predefined depth threshold is met.

Clause 4. The computerized method of clause 1, the first data type including intents, the one or more first probabilistic annotations corresponding to second data types including one or more of files, inputs, outputs, actions, entities, or sentiments.

Clause 5. The computerized method of clause 1, further comprising: selecting, from the set of candidate deterministic annotations, one or more second deterministic annotations in accordance with the annotation selection rules; generating a second synthesizing instruction for input to the synthesizing language model based on the first datapoint, the one or more second deterministic annotations, the synthesizing instruction template, and the scenario description; synthesizing a second input prompt and one or more second probabilistic annotations by the synthesizing language model based on the second synthesizing instruction; and adding a second datapoint to the annotated contextualized dataset, the second datapoint including the one or more second deterministic annotations, the second input prompt, and the one or more second probabilistic annotations.

Clause 6. The computerized method of clause 1, further comprising performing a task alignment post-processing task on the first datapoint of the annotated contextualized dataset to replace one or more portions of the first datapoint with replacement portions.

Clause 7. The computerized method of clause 1, the scenario description further specifying a style.

Clause 8. A system for synthesizing an annotated contextualized dataset for a machine learning model, comprising: one or more hardware processors; an annotation identifier stored in memory and executable by the one or more hardware processors and configured to perform operations comprising selecting one or more first deterministic annotations from a set of candidate deterministic annotations, wherein the set of candidate deterministic annotations correspond to a first data type identified in accordance with annotation selection rules; a datapoints generator stored in memory and executable by the one or more hardware processors and configured to perform operations comprising: generating a first synthesizing instruction for input to a synthesizing language model based on the one or more first deterministic annotations, a synthesizing instruction template, and a scenario description specifying a task of a specified domain for which the machine learning model is to be trained or evaluated; and synthesizing a first input prompt and one or more first probabilistic annotations by the synthesizing language model based on the first synthesizing instruction; and a datapoints validator stored in memory and executable by the one or more hardware processors and configured to perform operations comprising adding a first datapoint to the annotated contextualized dataset, the first datapoint including the one or more first deterministic annotations, the first input prompt, and the one or more first probabilistic annotations.

Clause 9. The system of clause 8, wherein the one or more first deterministic annotations and the one or more first probabilistic annotations are associated with the first input prompt in the first datapoint.

Clause 10. The system of clause 8, wherein additional datapoints are generated for inclusion in the annotated contextualized dataset with the first datapoint until a predefined depth threshold is met.

Clause 11. The system of clause 8, the first data type including intents, the one or more first probabilistic annotations corresponding to second data types including one or more of files, inputs, outputs, actions, entities, or sentiments.

Clause 12. The system of clause 8, the annotation identifier further configured to perform operations comprising selecting, from the set of candidate deterministic annotations, one or more second deterministic annotations in accordance with the annotation selection rules; the datapoints generator further configured to perform operations comprising: generating a second synthesizing instruction for input to the synthesizing language model based on the first datapoint, the one or more second deterministic annotations, the synthesizing instruction template, and the scenario description; and synthesizing a second input prompt and one or more second probabilistic annotations by the synthesizing language model based on the second synthesizing instruction; and the datapoints validator further configured to perform operations comprising adding a second datapoint to the annotated contextualized dataset, the second datapoint including the one or more second deterministic annotations, the second input prompt, and the one or more second probabilistic annotations.

Clause 13. The system of clause 8, further comprising a datapoint task aligner stored in memory and executable by the one or more hardware processors and configured to perform operations comprising performing a task alignment post-processing task on the first datapoint of the annotated contextualized dataset to replace one or more portions of the first datapoint with replacement portions.

Clause 14. The system of clause 8, the scenario description further specifying a style.

Clause 15. One or more tangible processor-readable storage media embodied with instructions for executing on one or more processors and circuits of a computing device a process for synthesizing an annotated contextualized dataset for a machine learning model, the process comprising: selecting one or more first deterministic annotations from a set of candidate deterministic annotations, wherein the set of candidate deterministic annotations correspond to a first data type identified in accordance with annotation selection rules; generating a first synthesizing instruction for input to a synthesizing language model based on the one or more first deterministic annotations, a synthesizing instruction template, and a scenario description specifying a task of a specified domain for which the machine learning model is to be trained or evaluated; synthesizing a first input prompt and one or more first probabilistic annotations by the synthesizing language model based on the first synthesizing instruction; and adding a first datapoint to the annotated contextualized dataset, the first datapoint including the one or more first deterministic annotations, the first input prompt, and the one or more first probabilistic annotations.

Clause 16. The one or more tangible processor-readable storage media of clause 15, wherein the one or more first deterministic annotations and the one or more first probabilistic annotations are associated with the first input prompt in the first datapoint.

Clause 17. The one or more tangible processor-readable storage media of clause 15, the process further comprising generating additional datapoints for inclusion in the annotated contextualized dataset with the first datapoint until a predefined depth threshold is met.

Clause 18. The one or more tangible processor-readable storage media of clause 15, the first data type including intents, the one or more first probabilistic annotations corresponding to second data types including one or more of files, inputs, outputs, actions, entities, or sentiments.

Clause 19. The one or more tangible processor-readable storage media of clause 15, the process further comprising: selecting, from the set of candidate deterministic annotations, one or more second deterministic annotations in accordance with the annotation selection rules; generating a second synthesizing prompt for input to the synthesizing language model based on the first datapoint, the one or more second deterministic annotations, the synthesizing instruction template, and the scenario description; synthesizing a second input prompt and one or more second probabilistic annotations by the synthesizing language model based on the second synthesizing prompt; and adding a second datapoint to the annotated contextualized dataset, the second datapoint including the one or more second deterministic annotations, the second input prompt, and the one or more second probabilistic annotations.

Clause 20. The one or more tangible processor-readable storage media of clause 15, the process further comprising performing a task alignment post-processing task on the first datapoint of the annotated contextualized dataset to replace one or more portions of the first datapoint with replacement portions.

Clause 21. A system of synthesizing an annotated contextualized dataset for a machine learning model, the computerized method comprising: means for selecting one or more first deterministic annotations from a set of candidate deterministic annotations, wherein the set of candidate deterministic annotations correspond to a first data type identified in accordance with annotation selection rules; means for generating a first synthesizing instruction for input to a synthesizing language model based on the one or more first deterministic annotations, a synthesizing instruction template, and a scenario description specifying a task of a specified domain for which the machine learning model is to be trained or evaluated; means for synthesizing a first input prompt and one or more first probabilistic annotations by the synthesizing language model based on the first synthesizing instruction; and means for adding a first datapoint to the annotated contextualized dataset, the first datapoint including the one or more first deterministic annotations, the first input prompt, and the one or more first probabilistic annotations.

Clause 22. The system of clause 21, the scenario description further specifying a style.

Clause 23. The system of clause 21, wherein the one or more first deterministic annotations and the one or more first probabilistic annotations are associated with the first input prompt in the first datapoint.

Clause 24. The system of clause 21, further comprising: means for generating additional datapoints for inclusion in the annotated contextualized dataset with the first datapoint until a predefined depth threshold is met.

Clause 25. The system of clause 21, the first data type including intents, the one or more first probabilistic annotations corresponding to second data types including one or more of files, inputs, outputs, actions, entities, or sentiments.

Clause 26. The system of clause 21, further comprising: means for selecting, from the set of candidate deterministic annotations, one or more second deterministic annotations in accordance with the annotation selection rules; means for generating a second synthesizing instruction for input to the synthesizing language model based on the first datapoint, the one or more second deterministic annotations, the synthesizing instruction template, and the scenario description; means for synthesizing a second input prompt and one or more second probabilistic annotations by the synthesizing language model based on the second synthesizing instruction; and means for adding a second datapoint to the annotated contextualized dataset, the second datapoint including the one or more second deterministic annotations, the second input prompt, and the one or more second probabilistic annotations.

Clause 27. The system of clause 21, further comprising means for performing a task alignment post-processing task on the first datapoint of the annotated contextualized dataset to replace one or more portions of the first datapoint with replacement portions.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computerized method of synthesizing an annotated contextualized dataset for a machine learning model, the computerized method comprising:
selecting one or more first deterministic annotations from a set of candidate deterministic annotations, wherein the set of candidate deterministic annotations correspond to a first data type identified in accordance with annotation selection rules;
generating a first synthesizing instruction for input to a synthesizing language model based on the one or more first deterministic annotations, a synthesizing instruction template, and a scenario description specifying a task of a specified domain for which the machine learning model is to be trained or evaluated;
synthesizing a first input prompt and one or more first probabilistic annotations by the synthesizing language model based on the first synthesizing instruction; and
adding a first datapoint to the annotated contextualized dataset, the first datapoint including the one or more first deterministic annotations, the first input prompt, and the one or more first probabilistic annotations.

2. The computerized method of claim 1, wherein the one or more first deterministic annotations and the one or more first probabilistic annotations are associated with the first input prompt in the first datapoint.

3. The computerized method of claim 1, further comprising:
generating additional datapoints for inclusion in the annotated contextualized dataset with the first datapoint until a predefined depth threshold is met.

4. The computerized method of claim 1, the first data type including intents, the one or more first probabilistic annotations corresponding to second data types including one or more of files, inputs, outputs, actions, entities, or sentiments.

5. The computerized method of claim 1, further comprising:
selecting, from the set of candidate deterministic annotations, one or more second deterministic annotations in accordance with the annotation selection rules;
generating a second synthesizing instruction for input to the synthesizing language model based on the first datapoint, the one or more second deterministic annotations, the synthesizing instruction template, and the scenario description;
synthesizing a second input prompt and one or more second probabilistic annotations by the synthesizing language model based on the second synthesizing instruction; and
adding a second datapoint to the annotated contextualized dataset, the second datapoint including the one or more second deterministic annotations, the second input prompt, and the one or more second probabilistic annotations.

6. The computerized method of claim 1, further comprising performing a task alignment post-processing task on the first datapoint of the annotated contextualized dataset to replace one or more portions of the first datapoint with replacement portions.

7. The computerized method of claim 1, the scenario description further specifying a style.

8. A system for synthesizing an annotated contextualized dataset for a machine learning model, comprising:
one or more hardware processors;
an annotation identifier stored in memory and executable by the one or more hardware processors and configured to perform operations comprising selecting one or more first deterministic annotations from a set of candidate deterministic annotations, wherein the set of candidate deterministic annotations correspond to a first data type identified in accordance with annotation selection rules;
a datapoints generator stored in memory and executable by the one or more hardware processors and configured to perform operations comprising:
generating a first synthesizing instruction for input to a synthesizing language model based on the one or more first deterministic annotations, a synthesizing instruction template, and a scenario description specifying a task of a specified domain for which the machine learning model is to be trained or evaluated; and
synthesizing a first input prompt and one or more first probabilistic annotations by the synthesizing language model based on the first synthesizing instruction; and
a datapoints validator stored in memory and executable by the one or more hardware processors and configured to perform operations comprising adding a first datapoint to the annotated contextualized dataset, the first datapoint including the one or more first deterministic annotations, the first input prompt, and the one or more first probabilistic annotations.

9. The system of claim 8, wherein the one or more first deterministic annotations and the one or more first probabilistic annotations are associated with the first input prompt in the first datapoint.

10. The system of claim 8, wherein additional datapoints are generated for inclusion in the annotated contextualized dataset with the first datapoint until a predefined depth threshold is met.

11. The system of claim 8, the first data type including intents, the one or more first probabilistic annotations corresponding to second data types including one or more of files, inputs, outputs, actions, entities, or sentiments.

12. The system of claim 8,
the annotation identifier further configured to perform operations comprising selecting, from the set of candidate deterministic annotations, one or more second deterministic annotations in accordance with the annotation selection rules;
the datapoints generator further configured to perform operations comprising:
generating a second synthesizing instruction for input to the synthesizing language model based on the first datapoint, the one or more second deterministic annotations, the synthesizing instruction template, and the scenario description; and
synthesizing a second input prompt and one or more second probabilistic annotations by the synthesizing language model based on the second synthesizing instruction; and
the datapoints validator further configured to perform operations comprising adding a second datapoint to the annotated contextualized dataset, the second datapoint including the one or more second deterministic annotations, the second input prompt, and the one or more second probabilistic annotations.

13. The system of claim 8, further comprising a datapoint task aligner stored in memory and executable by the one or more hardware processors and configured to perform operations comprising performing a task alignment post-processing task on the first datapoint of the annotated contextualized dataset to replace one or more portions of the first datapoint with replacement portions.

14. The system of claim 8, the scenario description further specifying a style.

15. One or more tangible processor-readable storage media embodied with instructions for executing on one or more processors and circuits of a computing device a process for synthesizing an annotated contextualized dataset for a machine learning model, the process comprising:
selecting one or more first deterministic annotations from a set of candidate deterministic annotations, wherein the set of candidate deterministic annotations correspond to a first data type identified in accordance with annotation selection rules;
generating a first synthesizing instruction for input to a synthesizing language model based on the one or more first deterministic annotations, a synthesizing instruction template, and a scenario description specifying a task of a specified domain for which the machine learning model is to be trained or evaluated;
synthesizing a first input prompt and one or more first probabilistic annotations by the synthesizing language model based on the first synthesizing instruction; and
adding a first datapoint to the annotated contextualized dataset, the first datapoint including the one or more first deterministic annotations, the first input prompt, and the one or more first probabilistic annotations.

16. The one or more tangible processor-readable storage media of claim 15, wherein the one or more first deterministic annotations and the one or more first probabilistic annotations are associated with the first input prompt in the first datapoint.

17. The one or more tangible processor-readable storage media of claim 15, the process further comprising generating additional datapoints for inclusion in the annotated contextualized dataset with the first datapoint until a predefined depth threshold is met.

18. The one or more tangible processor-readable storage media of claim 15, the first data type including intents, the one or more first probabilistic annotations corresponding to second data types including one or more of files, inputs, outputs, actions, entities, or sentiments.

19. The one or more tangible processor-readable storage media of claim 15, the process further comprising:
selecting, from the set of candidate deterministic annotations, one or more second deterministic annotations in accordance with the annotation selection rules;
generating a second synthesizing prompt for input to the synthesizing language model based on the first datapoint, the one or more second deterministic annotations, the synthesizing instruction template, and the scenario description;
synthesizing a second input prompt and one or more second probabilistic annotations by the synthesizing language model based on the second synthesizing prompt; and
adding a second datapoint to the annotated contextualized dataset, the second datapoint including the one or more second deterministic annotations, the second input prompt, and the one or more second probabilistic annotations.

20. The one or more tangible processor-readable storage media of claim 15, the process further comprising performing a task alignment post-processing task on the first datapoint of the annotated contextualized dataset to replace one or more portions of the first datapoint with replacement portions.
